(19) United States
(12) Patent Application Publication
(10) Pub. No.: US 2005/0015499 A1
(43) Pub. Date: Jan. 20, 2005

(54) Method and apparatus for SIP user agent discovery of configuration server

(76) Inventor: Georg Mayer, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/438,747

(22) Filed: May 15, 2003

(51) Int. Cl. G06F 15/16

(52) U.S. Cl. 709/228

(57) ABSTRACT

A method and equipment by which a telecommunication terminal (10) discovers (and may enroll with) a Service Configuration Server (17) having (at least links to) configuration information needed by the terminal in performing Session Initiation Protocol (SIP) signalling to a multimedia enabling system (13) having a home service proxy (14) and an SIP outbound proxy (12), the method including: a step (20) in which the home service proxy obtains a configuration event filter for the terminal; the method characterized by: a step (21) in which the terminal creates and transmits to the SIP outbound proxy for routing to the home service proxy a SIP SUBSCRIBE request for a configuration event package, including in the request its own uniform resource identifier (URI) in the request URI. The home service proxy then redirects the SIP SUBSCRIBE request to the Service Configuration Server based on the configuration event filter for the terminal.

### TECHNICAL FIELD

The present invention pertains to the field of telecommunications. More particularly, the present invention pertains to use of Session Initiation Protocol (SIP) signalling between telecommunication devices in a telecommunications network, and in particular to the so-called discovery process by which a telecommunication terminal learns the address and port at which it should enroll with a so-called configuration server.

### BACKGROUND ART

The present invention concerns Session Initiation Protocol (SIP) signalling for communication of multimedia via for example an Internet Protocol (IP) Multimedia Subsystem (IMS) provided as part of 3GPP (Third Generation Partnership Program) UMTS (Universal Mobile Telecommunications System) networks, as set out in various 3GPP specifications including 3GPP Technical Specification (TS) 23.228, “IP Multimedia Subsystem (IMS); Stage 2.” The IMS includes all UMTS core network elements used to provide multimedia services, including the collection of signalling and bearer related network elements defined in 3GPP TS 23.002. The IMS includes various related CSCF (call state control function) elements, which in combination provide functionality for routing packets conveying multimedia. Signalling (for setting up end-to-end communications) between a wireless terminal and IMS is according to SIP. The invention is also of use for communication by a non-3G terminal, and in particular in case of other than wireless telecommunication terminals, e.g. a SIP stack on a laptop or other personal computer.

SIP is defined by the IETF (Internet Engineering Task Force) in RFC (Request for Comment) 3261 and is an application-layer protocol used for (among other things) establishing, handling and releasing end-to-end multimedia sessions via IMS, which makes possible (via control signalling) providing multimedia content according to IP via the packet-switched domain (vs. the circuit-switched domain) of UMTS. There are several additions to SIP, including allowing event notification based on SIP; event notification is the basis for the so-called (SIP-based) Presence Service as well as other services.

An IETF document entitled “A Framework for SIP User Agent Configuration,” hereinafter the Framework, defines the application of a set of protocols for configuring a so-called SIP user agent (so as to be able to signal with IMS for sending and receiving multimedia). A SIP user agent is the element of a device (a wireless terminal or a server) that performs signalling according to SIP. Currently, SIP user agent vendors use proprietary mechanisms of delivering configuration to a user agent. The Framework provides a standard way of configuring SIP user agents, i.e. a standard for how a user agent vendor delivers a (possibly proprietary) configuration data profile (having a possibly proprietary binary or text format). The Framework relies on use of so-called Service Configuration Servers (one or more per operator network—if discovery is not done via a fixed URI, as proposed in the Framework, there can be more than one server) to deliver configuration data to user agents from multiple vendors. According to the Framework, the SIP user agent must discover—in what is called a “discovery” process—how and from where both to retrieve its initial/base configuration and also to be notified of changes and updates to the configuration it is using. When a user agent is properly configured, it can be functional without user or administrative intervention. Besides setting out how a SIP user agent can discover a configuration server (in the discovery process), the Framework also defines how SIP user agents can automatically: enroll with the configuration server (Enrollment); retrieve configuration data (Configuration Retrieval); receive notification of configuration changes (Change Notification); and upload configuration data changes back to the server (Configuration Upload). Of these, it is the discovery and enrollment process that are pertinent to the present invention.

Discovery is the process by which a user agent finds the address and port at which it can enroll with the configuration server, i.e. the user agent must find the address to use in the request URI and To header field of the SIP SUBSCRIBE message. According to the Framework, the URL should use the user id: sipuaconfig. From a SIP perspective the configuration server is simply a user agent. Using the well known user id makes it easy for proxy servers to be provisioned to route an enrollment request from the device hosting a user agent to the appropriate configuration server for the domain.

Enrollment is the process by which a user agent can make itself known to the configuration server, and involves sending a SIP SUBSCRIBE. In enrolling, the user agent must provide identity information, name the configuration data profile it is requesting and name one or more (acceptable) protocols for configuration retrieval. A user agent should also subscribe to a mechanism for notification of configuration changes. Each profile requires a separate enrollment or subscription. As a result of enrollment, a user agent receives a URL (uniform resource locator) for each of the configuration data profiles that the configuration server is able to provide and that the user indicated during subscription. (A user indicates a profile package in the Event header of a SUBSCRIBE.)

For the discovery procedure according to the IETF document, a UE (user equipment, i.e. a wireless terminal) specifies a SIP Event Package that allows the UE to subscribe to a Service Configuration Server, which then notifies the UE about the actual configuration or sends to the UE a link for the configuration information. As there is no single discovery mechanism which will work in all network environments, a number of discovery mechanisms are defined, and an order is prescribed in which a user agent should try them until one succeeds, and thus the procedure for discovery set out in the Framework is rather elaborate. One mechanism of the discovery procedure set out in the Framework involves making a query according to DHCP (dynamic host control protocol) and another mechanism involves making a DNS (domain name service) query.

However, to use the services of IMS, a UE currently does not necessarily need to implement DHCP and DNS. Moreover, although a UE using SIP signalling to obtain the address of an SIP Outbound Proxy can use DHCP and DNS protocols, a UE has other means of determining the address-of an SIP Outbound Proxy, via for example PS (packet-switched) domain-related procedures, such as the PCO (protocol configuration option) IE (information element) in the PDP (packet data protocol) CONTEXT ACTIVATE message for the Signalling PDP context. Furthermore, the discovery mechanism depends on the state of configuration the UE has already reached. If the UE e.g. is not aware of the Outbound Proxy (the P-CSCF in case of IMS) and a Home Service Proxy (the S-CSCF in case of IMS), then it has to discover the service configuration server “from scratch.” If those entities are assigned, it can make use of the services that are provided by them and e.g. use a simpler discovery mechanism.

Thus, it would be advantageous to have a simpler discovery procedure by which a UE obtains the address of the Service Configuration Server so as to be able to subscribe and then obtain a link to configuration information (on the Service Configuration Server).

### DISCLOSURE OF THE INVENTION

Accordingly, in a first aspect of the invention, a method is provided by which a telecommunication terminal discovers a Service Configuration Server able to provide access to configuration information needed by the terminal in performing Session Initiation Protocol (SIP) signalling to a multimedia enabling system having a home service proxy and a SIP outbound proxy, the method characterized by: steps in which the terminal creates and transmits to the SIP outbound proxy for routing to the home service proxy a SIP SUBSCRIBE request for a configuration event package, including in the request its own uniform resource identifier (URI) in the request URI.

In accord with the first aspect of the invention, the method may be further characterized by: a step in which the home service proxy routes the SIP SUBSCRIBE request for a configuration event package to the Service Configuration Server based on a configuration event filter for the terminal obtained by the home service proxy.

Also in accord with the first aspect of the invention, the method may be further characterized by: a step in which the Service Configuration Server, in response to the SUBSCRIBE request, sends to the terminal a message including a port and address to be used by the terminal in communicating with the Service Configuration Server. Further, in the step in response to the SUBSCRIBE request, the Service Configuration Server may also enroll the terminal and include in the message it sends to the terminal either service configuration data for the terminal or a link to the service configuration data.

Also in accord with the first aspect of the invention, the multimedia enabling system may be an Internet Protocol (IP) Multimedia Subsystem (IMS) including a including a home subscriber server (HSS), the home service proxy may be a server hosting serving-call state control function (S-CSCF) functionality, the method may also include a step in which the S-CSCF functionality downloads from the HSS a configuration event filter for the terminal, and the method may be further characterized by: a step in which the home service proxy routes the SIP SUBSCRIBE request for a configuration event package to the Service Configuration Server based on the configuration event filter.

In a second aspect of the invention, a terminal is provided equipped for Session Initiation Protocol (SIP) signalling to a multimedia enabling system having a SIP outbound proxy and a home service proxy, the terminal adapted to discover an address and port for a Service Configuration Server able to provide access to configuration information needed by the terminal in performing the SIP signalling, the terminal characterized by: means by which the terminal creates and transmits to the SIP outbound proxy for routing to the home service proxy a SIP SUBSCRIBE request for a configuration event package, including in the request its own uniform resource identifier (URI) in the request URI.

In a third aspect of the invention, a telecommunication system is provided, comprising: a terminal as in the second aspect of the invention; the multimedia enabling system; and the Service Configuration Server.

In a fourth aspect of the invention, a computer program product is provided comprising: a computer readable storage structure embodying computer program code thereon for execution by a computer processor in a telecommunication terminal, with said computer program code characterized in that it includes instructions for performing the steps of the method according to the first aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of an IMS network and a UE communicating according to the invention so as to have the UE discover the address of a local Service Configuration Server and a port for use in communicating with it; and

FIG. 2 is a flow chart illustrating a sequence of steps according to the invention performed by various of the elements of FIG. 1 leading to discovery by the UE of the address and port for a local Service Configuration Server.

### BEST MODE FOR CARRYING OUT THE INVENTION

The invention is described below in the context of a wireless terminal communicating with the IMS of a 3G network, i.e. per a UMTS network according to the 3GPP. It should be understood however, that the invention is applicable also to communication by a non-3G terminal, e.g. a SIP stack on a laptop or other personal computer or on any other telecommunication terminal, communicating wirelessly or via a wired connection.

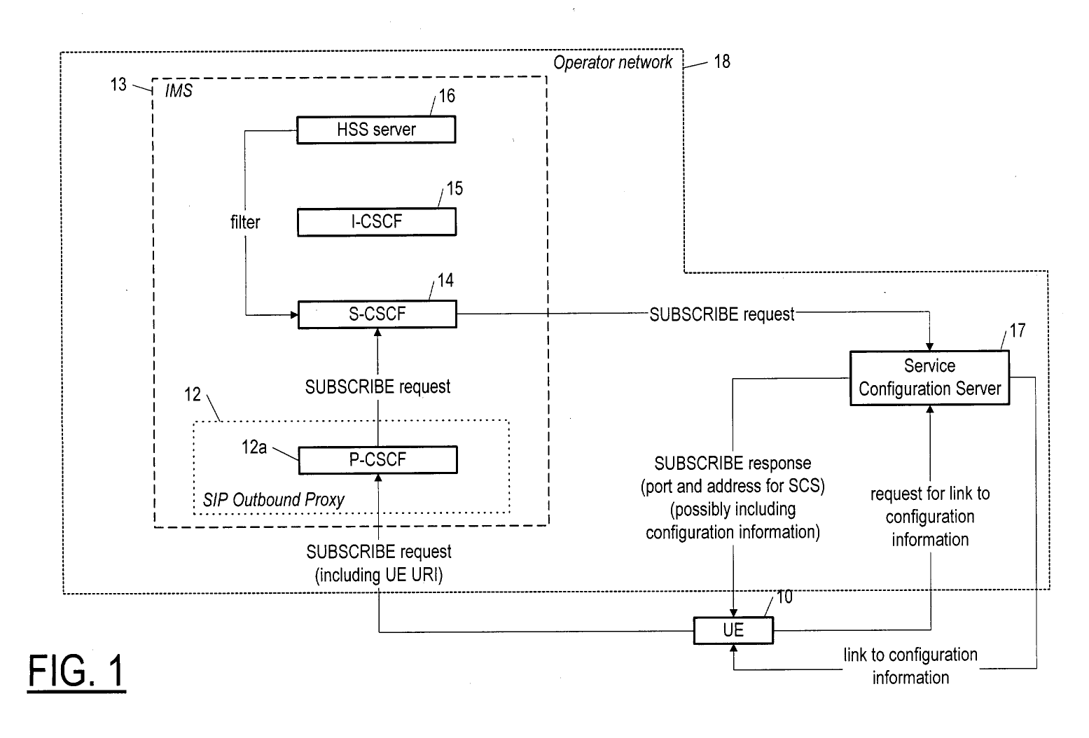

Referring now to FIG. 1, according to the invention, to determine the address of a Service Configuration Server 17 so as to obtain information for configuring for SIP signalling with IMS 13, the SIP user agent of a UE 10 transmits, via a radio access network (RAN) (not shown), to the IMS of an operator network 18 (assumed here to be the operator network to which the UE is subscribed) a SIP SUBSCRIBE request for a configuration event package, including in the request its own URI in the request URI. The request is then handled by the IMS 13 in the same way as e.g. a SUBSCRIBE request for a Presence Event Package, i.e. it is routed by an SIP outbound proxy server 12 (part of IMS), including S-CSCF (Serving-Call State Control Function) functionality 12a, to the server related to the Event indicated in the Event header of the SUBSCRIBE request; in case of a SUBSCRIBE request for a configuration event package, the request is routed to the Service Configuration Server 14 of the operator network. (It is assumed here that the UE knows the user's identity and so is able to include the URI for the UE in the SUBSCRIBE request, and it is also assumed here that the UE knows the address of the SIP Outbound Proxy 12, and so knows the address to send the SUBSCRIBE request to. If not, then it is assumed here that prior art methods are used to obtain any missing information. Within the IMS the UE is aware of this information due to the registration process it needs to perform prior to sending any other message (see 3GPP TS 24.229))

For example, according to the invention the UE 10, assumed here to have URI user1_publicl@homel.net so that the operator network has domain name homel.net, sends a SUBSCRIBE request to the SIP outbound proxy 12 with the following headers (in addition to others):

SUBSCRIBE sip:user1_public1@home1.net
From: sip:user1_public1@home1.net;tag=12345
To: sip:user1_public1@home1.net
Event: sip-config

The request is routed by the SIP outbound proxy server—having P-CSCF (proxy-call state control function) functionality—to the server hosting the S-CSCF (serving-call state control function) functionality 14 for the UE, i.e. normal IMS routing procedures are followed for routing the SUBSCRIBE request. Now, according to the invention, the S-CSCF 14 for the UE will have already downloaded from the HSS (Home Subscriber Server) (assumed here to be part of the same operator network 18, but could be in another operator network), during registration by the UE, a filter (i.e. filter criteria), called here a service configuration filter, stating e.g.:

```
IF request-URI = sip:user1_public1@home1.net
  AND request = SUBSCRIBE
  AND Event = sip-config
THEN forward to configuration-server.home1.net
```

(Filter criteria are not coded in this way; the above is provided in this way for readability.) Therefore the S-CSCF 14 forwards the request to the Service Configuration Server 17. In response, the Service Configuration Server 17 provides to the UE 10 (possibly via the P-CSCF functionality 12a, and via a RAN, not shown) the address and port the UE 10 can use to communicate with the Service Configuration Server 17. In some embodiments, the UE 10 then enrolls with the Service Configuration Server 17 in order to receive configuration information, using another SIP SUBSCRIBE request, this time directed to the part and address indicated by the Service Configuration Server 17. In such embodiments, following the enrollment procedure (not indicated in FIG. 1), the UE 10 requests from the Service Configuration Server 17a link to the configuration information, as shown in FIG. 1. The configuration information is typically a text file or binary file hosted on a server accessible to the UE 10 and proprietary to the vendor of the SIP user agent used by the UE 10. In other embodiment, as also indicated in FIG. 1, in response to its initial SIP SUBSCRIBE from the UE 10 (provided by the S-CSCF), the Service Configuration Server 17 enrolls the UE (so that a second SIP SUBSCRIBE from the UE 10 is not needed for enrollment), and sends to the UE 10 not only a port and address, but also the configuration information (or a link to the configuration information) needed by the UE 10.

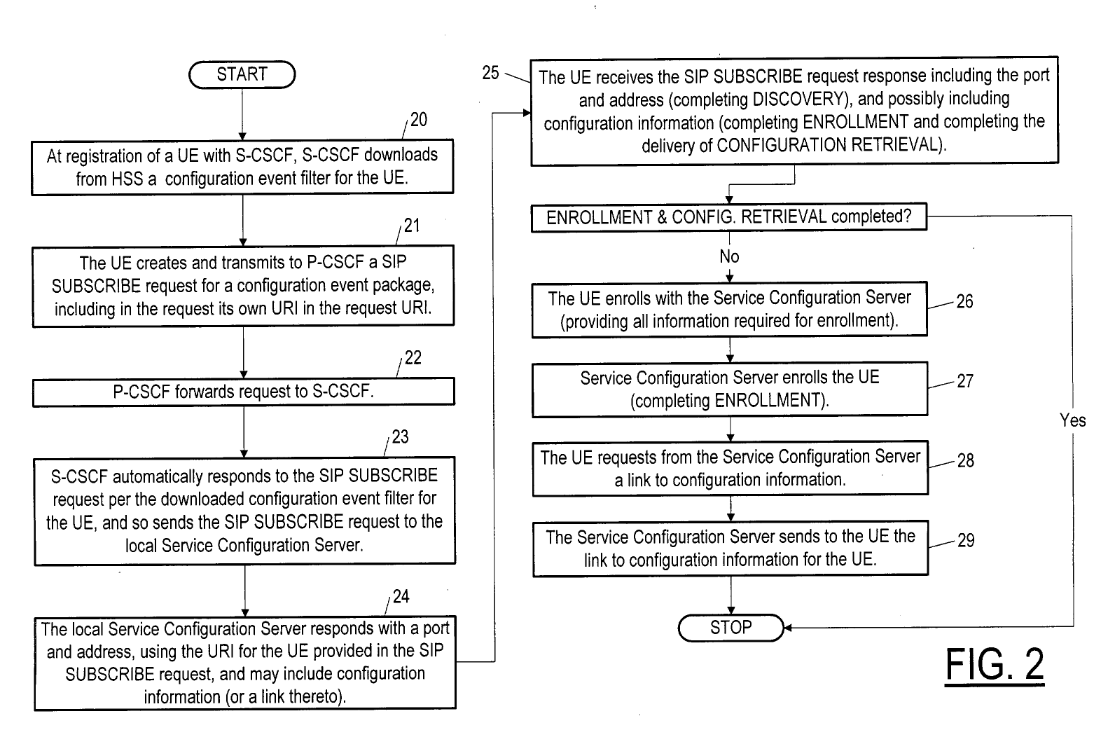

FIG. 2 sets out steps of a method according to the invention by which a UE discovers (determines a port and address for communication with) a local Service Configuration Server, steps performed by one or another indicated element of the system illustrated in FIG. 1, each such element having means for performing the respective steps indicated in FIG. 2. In a first step 20, at registration of a UE with S-CSCF functionality 14, the S-CSCF downloads from the HSS 16a configuration event filter for the UE. In a next step 21, the UE creates and transmits to the P-CSCF 12a/SIP outbound proxy 12 (for routing to the S-CSCF/SIP home service proxy 14) a SIP SUBSCRIBE request for a configuration event package, including in the request its own URI in the request URI. In a next step 22, the P-CSCF forwards the request to S-CSCF. In a next step 23, the S-CSCF automatically responds to the SIP SUBSCRIBE request per the downloaded configuration event filter for the UE, and so sends the SIP SUBSCRIBE request to the local Service Configuration Server 17. In a next step 24, the local Service Configuration Server responds to the UE (possibly via the P-CSCF 12a and via a RAN, not shown) with a port and address, using the URI for the UE provided in the SIP SUBSCRIBE request, and may include configuration information (or a link thereto). In a next step 25, the UE receives the SIP SUBSCRIBE request response including the port and address (completing the DISCOVERY process), and possibly including configuration information (and so possibly also completing ENROLLMENT and completing the delivery of CONFIGURATION RETRIEVAL). If the Service Configuration Server did not enroll the UE upon receiving the (first) SIP SUBSCRIBE request, then a series of further steps are performed leading to ENROLLMENT and CONFIGURATION RETRIEVAL, including a first step 26 in which the UE enrolls with the Service Configuration Server (providing all information required for enrollment), a next step 27 in which the Service Configuration Server enrolls the UE (completing ENROLLMENT), a next step 28 in which UE requests from the Service Configuration Server a link to configuration information, and a next step 29 in which the Service Configuration Server sends to the UE the link to configuration information for the UE or possibly the configuration information itself, completing CONFIGURATION RETRIEVAL; if only a link is provided, then the UE uses the link to obtain the configuration, and so completes CONFIGURATION RETRIEVAL.

As explained above, the invention is of use not only in case of IMS, but in case of a terminal (wireless or otherwise) communicating with any kind multimedia enabling system in which SIP signalling between the terminal and the multimedia enabling system is used. Also, the way the Service Configuration Server for a telecommunications terminal is located is up to the implementation/network configuration. For IMS the locating is done based on setting filter criteria in the HSS/S-CSCF as described above. In other implementations/network configurations, the terminal's registrar might itself provide the service configuration (or a link to the service configuration) to the terminal.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method by which a telecommunication terminal (10) discovers a Service Configuration Server (17) able to provide access to configuration information needed by the terminal (10) in performing Session Initiation Protocol (SIP) signalling to a multimedia enabling system (13) having a home service proxy (14) and a SIP outbound proxy (12), the method characterized by:
steps (21) in which the terminal (10) creates and transmits to the SIP outbound proxy (12) for routing to the home service proxy (14) a SIP SUBSCRIBE request for a configuration event package, including in the request its own uniform resource identifier (URI) in the request URI.

2. A method as in claim 1, further characterized by:
a step (23) in which the home service proxy (14) routes the SIP SUBSCRIBE request for a configuration event package to the Service Configuration Server (17) based on a configuration event filter for the terminal (10) obtained by the home service proxy (14).

3. A method as in claim 1, further characterized by:
a step (24) in which the Service Configuration Server (17), in response to the SUBSCRIBE request, sends to the terminal (10) a message including a port and address to be used by the terminal (10) in communicating with the Service Configuration Server (17).

4. A method as in claim 3, wherein in the step (24) in response to the SUBSCRIBE request, the Service Configuration Server (17) also enrolls the terminal (10) and includes in the message it sends to the terminal (10) either service configuration data for the terminal (10) or a link to the service configuration data.

5. A method as in claim 1, wherein the multimedia enabling system (13) is an Internet Protocol (IP) Multimedia Subsystem (IMS) including a including a home subscriber server (HSS) (16), wherein the home service proxy (14) is a server hosting serving-call state control function (S-CSCF) functionality, the method also including a step (20) in which the S-CSCF functionality (14) downloads from the HSS (16) a configuration event filter for the terminal (10), and the method further characterized by: a step (25) in which the home service proxy (14) routes the SIP SUBSCRIBE request for a configuration event package to the Service Configuration Server (17) based on the configuration event filter.

6. A terminal (10) equipped for Session Initiation Protocol (SIP) signalling to a multimedia enabling system (13) having a SIP outbound proxy (12) and a home service proxy (14), the terminal (10) adapted to discover an address and port for a Service Configuration Server (17) able to provide access to configuration information needed by the terminal (10) in performing the SIP signalling, the terminal (10) characterized by:
means (21) by which the terminal (10) creates and transmits to the SIP outbound proxy (12) for routing to the home service proxy (14) a SIP SUBSCRIBE request for a configuration event package, including in the request its own uniform resource identifier (URI) in the request URI.

7. A telecommunication system, comprising:
a terminal (10) as in claim 6;
the multimedia enabling system (13); and
the Service Configuration Server (17).

8. A computer program product comprising: a computer readable storage structure embodying computer program code thereon for execution by a computer processor in a telecommunication terminal (10), with said computer program code characterized in that it includes instructions for performing the steps of the method of claim 1.
